(19) United States
(12) Patent Application Publication
(10) Pub. No.: US 2009/0023033 A1
(43) Pub. Date: Jan. 22, 2009

(54) HIGHLY HYDROPHILIZED CARRIER, CATALYST-SUPPORTING CARRIER, FUEL-CELL ELECTRODE, THE MANUFACTURING METHODS THEREOF, AND POLYMER ELECTROLYTE FUEL CELL PROVIDED THEREWITH

(76) Inventors: Akira Tsujiko, Aichi (JP); Masahiro Ueda, Kyoto (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/278,075

(22) PCT Filed: Jan. 30, 2007
(86) PCT No.: PCT/JP2007/051877

§ 371 Date: Aug. 1, 2008

(30) Foreign Application Priority Data
Feb. 2, 2006 (JP) 2006-026106

(51) Int. Cl. H01M 8/10; H01M 4/00; B05D 5/12; H01M 4/88

(52) U.S. Cl. 429/30; 429/40; 427/77; 502/101

(57) ABSTRACT

A method for manufacturing a catalyst-supporting carrier composed of a catalyst-supporting carbon and a polyelectrolyte, and including a carbon having pores to support a catalyst, introducing a functional group functioning as a polymerization initiator to the surface and/or in the pores of the catalyst-supporting carbon, introducing an electrolyte monomer and thereby grafting it onto the catalyst supporting carbon carrier for polymerizing by radical polymerization, and hydrolyzing at least part of the polymerized polyelectrolyte by a strong alkali. By using this catalyst-supporting carrier, electrode reaction is effectively facilitated, and the fuel-cell electrical efficiency can be improved. Further, an electrode having excellent properties and a polymer electrolyte fuel cell provided with such electrode and capable of obtaining high cell output are provided.

### TECHNICAL FIELD

The present invention relates to a highly hydrophilized carrier, a catalyst-supporting carrier, a fuel-cell electrode, the manufacturing methods thereof, and a polymer electrolyte fuel cell provided therewith.

### BACKGROUND ART

Since a polymer electrolyte fuel cell having a polymer electrolyte membrane can be easily made smaller and lighter, the practical application thereof to a power supply of a mobile vehicle, such as an electric vehicle, or of a small cogeneration system is expected, for example.

Electrode reaction in each catalyst layer of the anode and the cathode in the polymer electrolyte fuel cell progresses in a three-phase interface (to be hereafter referred to as a reaction site), in which each of the reactant gas, catalyst, fluorine-containing ion exchange resin (electrolyte) simultaneously exist. For this reason, conventionally, in such polymer electrolyte fuel cell, the catalyst is coated with the fluorine-containing ion exchange resin that is the same type as or a different type from polymer electrolyte membrane, so as to use it as a constituent material for the catalyst layer, such as a metal-supporting carbon formed by allowing a carbon black carrier having a large specific surface area to support a metal catalyst such as platinum.

Thus, the generation of protons and electrons is conducted in the anode under a three-phase coexistence of the catalyst, carbon particles, and electrolyte. Namely, the electrolyte, through which protons are conducted, and the carbon particles, through which electrons are conducted, coexist with each other. Further, since the catalyst coexists with the electrolyte and the carbon particles, hydrogen gas is reduced. Thus, the more catalyst supported by the carbon particles there is, the higher electrical efficiency can be obtained. This is also the case with the cathode. However, since such catalyst used in a fuel cell is a noble metal such as platinum, if the amount of catalyst supported by the carbon particles is increased, the cost of manufacturing a fuel cell is increased.

In a conventional method for manufacturing a catalyst layer, ink, in which electrolyte such as Nafion (trade name) and catalyst powder such as platinum or carbon are dispersed in a solvent, is cast and dried. Since such catalyst powder has many pores, each having a size of several nm to several dozen nm, and polyelectrolyte having a large molecular size cannot enter the nano-sized pores. Thus, it can be presumed that the catalyst surface alone is coated. For this reason, platinum in the pores cannot be effectively used, which is a cause of decreasing catalyst performance.

In response, for the purpose of improving electrical efficiency without increasing the amount of catalyst supported by carbon particles, JP Patent Publication (Kokai) No. 2002-373662 A below discloses a method for manufacturing a fuel-cell electrode. In accordance with the method, electrode paste, in which catalyst-supporting particles, to which catalyst particles are supported on the surface thereof, and ion-conducting polymer are mixed, is treated by a solution containing catalytic metal ions, ionic substitution of the ion-conducting polymer for the catalytic metal ion is carried out, and the catalytic metal ion is then reduced.

Meanwhile, for the purpose of manufacturing an detect-free ion-exchange membrane having sufficient heat resistance and chemical resistance, JP Patent Publication (Kokai) No. 6-271687 A (1994) discloses a method for manufacturing an ion-exchange membrane, by which a substrate composed of a fluorine-based polymer is impregnated with a polymerizable monomer so that the polymerizable monomer is supported by the substrate, part of the polymerizable monomer is reacted by irradiation of ionizing radiation at the former stage, the remnant is polymerized by heating in the presence of a polymerization initiator at the latter stage, and an ion-exchange group is introduced if needed. In the method, the quantity of the radiation is set to be a specified level at the former stage.

### DISCLOSURE OF THE INVENTION

### Problems To Be Solved By the Invention

However, even when such treatment as disclosed in Patent Document 1 is conducted, there is a limit to improving electrical efficiency. This is because the catalyst-supporting carbon has nanometer-order pores that high polymer cannot enter, and catalyst such as platinum adsorbed to such pores cannot be part of the above three-phase interface; that is, the reaction site. Thus, it is a problem that such polyelectrolyte cannot enter such carbon pores.

Further, the method of Patent Document 2 relates to a method for manufacturing an ion-exchange membrane, and its operation, such as radiation irradiation, is not easy.

The present invention has been made in view of the problems of the above conventional technologies, and it is an object of the present invention to improve catalytic efficiency by sufficiently assuring the three-phase interface, in which reactant gas, catalyst, and electrolyte meet in a carbon. Thus, electrode reaction is effectively facilitated, thereby improving fuel-cell electrical efficiency. Further, it is another object of the present invention to provide an electrode having excellent properties and a polymer electrolyte fuel cell that is provided with such electrode and that is capable of obtaining high cell output. Note that the present invention is not limited to a polymer electrolyte fuel cell, but it may be widely applied to various types of catalyst using carbon carriers.

### Means of Solving the Problems

The present inventor focused his attention on the fact that, while generating polyelectrolyte in nanometer-order pores of a carbon in an in-situ manner is effective in improving the use efficiency of catalytic metal such as Pt by using a living polymerization method, excessive graft polymerization of the polyelectrolyte to the carrier inhibits contact between carriers, which results in decreasing electron conductivity. Thus, the present inventor found that the above problems are solved by hydrolyzing at least part of the polyelectrolyte by a strong alkali, whereby the present invention has been completed.

Namely, in a first aspect, the present invention is a method for manufacturing a highly-hydrophilized carrier composed of a carbon carrier and polyelectrolyte. The method includes a step of introducing a functional group functioning as a polymerization initiator to the surface of a carbon carrier having pores and/or in the pores thereof, a step of introducing an electrolyte monomer or an electrolyte monomer precursor and polymerizing the electrolyte monomer or the electrolyte monomer precursor to the polymerization initiator as a starting point, and a step of hydrolyzing at least part of the polymerized polyelectrolyte with a strong alkali. Since the surface of the highly-hydrophilized carrier of the present invention is thinly coated with polyelectrolyte, it is rich in hydrophilicity, and since at least part of the polyelectrolyte is hydrolyzed by a strong alkali, physical and electrical contacts between highly-hydrophilized carriers are facilitated. Thus, the highly-hydrophilized carrier exhibits high dispersibility without aggregating in water or the like, and electrical conductivity is also improved.

In a second aspect, the present invention is a method for manufacturing a catalyst-supporting carrier composed of a catalyst-supporting carbon and polyelectrolyte. The method includes a step of allowing a carbon having nanometer-order pores to support catalyst, a step of introducing a functional group functioning as a polymerization initiator to the surface and/or pores of the catalyst-supporting carbon, a step of introducing an electrolyte monomer or an electrolyte monomer precursor and polymerizing the electrolyte monomer or the electrolyte monomer precursor to the polymerization initiator as a starting point, and a step of hydrolyzing at least part of the polymerized polyelectrolyte with a strong alkali. In this way, the surface and/or pores of the catalyst-supporting carbon can be thinly coated with the polyelectrolyte, and all the supported catalyst including the catalyst such as platinum in the pores can be effectively used. Further, since at lease part of the polyelectrolyte is hydrolyzed by a strong alkali, physical and electrical contacts between highly-hydrophilized carriers are facilitated, thereby improving the electrical conductivity of the catalyst-supporting carriers as a whole.

In order to hydrolyze at least part of the polyelectrolyte, a strong alkali can be used. Specifically, it is preferable to hydrolyze at least part of the polyelectrolyte with KOH and/or NaOH as the strong alkali. If NaI is used instead of a strong alkali, a sulfonate ester bond in a graft chain is mainly hydrolyzed, and therefore it becomes difficult to hydrolyze at least part of the polyelectrolyte with a strong alkali in a manner expected by the present invention.

In order to have the molecular weight of the electrolyte monomer or the electrolyte monomer precursor in an optimum range after polymerization, it is preferable to conduct living polymerization. Thus, as the above polymerization initiator, a living radical polymerization initiator or a living anion polymerization initiator is preferable. While the living radical polymerization initiator is not particularly limited, preferable examples thereof include 2-bromo isobutyryl bromide. While the electrolyte monomer is not particularly limited, an unsaturated compound having a sulfonic acid group, a phosphate group, a carboxylic acid group, or an ammonium group can be used. Further, while the electrolyte monomer precursor is not particularly limited, an unsaturated compound capable of generating a sulfonic acid group, a phosphate group, a carboxylic acid group, or an ammonium group upon hydrolysis or the like after polymerization or an unsaturated compound capable of introducing a sulfonic acid group, a phosphate group, a carboxylic acid group, or an ammonium group after polymerization can be used. Among these, ethyl styrenesulfonate is preferably exemplified.

In the present invention, from the viewpoint of catalyst use efficiency, it is preferable that the ratio of the weight of the electrolyte to the sum of the weight of electrolyte and the weight of the catalyst-supporting carbon is less than 10% in the step of polymerizing the electrolyte monomer or the electrolyte monomer precursor. By adjusting the concentration of the electrolyte monomer or the electrolyte monomer precursor, the ratio of the weight of the electrolyte to the sum of the weight of the electrolyte and the weight of the catalyst-supporting carbon can be set to be a predetermined ratio. Regarding a fuel-cell catalyst layer, both supplies of electrons and protons to the catalyst need to be considered. In the present invention, while the supply of protons is facilitated, that is not sufficient. In consideration of platinum utilization and from the viewpoint of supplying electrons, it is preferable that the ratio of the weight of the electrolyte to the sum of the weight of the electrolyte and the weight of the catalyst-supporting carbon is less than 10%.

While the catalyst-supporting carrier of the present invention can be widely applied to various types of catalyst using carbon carriers, particularly, it is suitably used for a fuel-cell electrode. Thus, in a third aspect, the present invention is a method for manufacturing a fuel-cell electrode composed of a catalyst-supporting carbon and polyelectrolyte, and the polyelectrolyte and the catalyst can be allowed to coexist on the surface of a carbon having pores and in the nanometer-level pores thereof.

Thus, such fuel-cell electrode obtained by the present invention improves catalyst utilization, and in a fuel-cell electrode including ion-exchange resin, carbon particles, and catalyst, since the catalyst that is submerged deep in carbon nanopores forms part of the three-phase interface, existing catalyst can be used for reaction without waste. Thus, since an electrolyte monomer in a monomer state and a catalyst carrier are mixed and then polymerized by polymerization, ion-exchange paths are formed in the pores of the carrier, thereby improving catalyst utilization and electrical efficiency, even when the quantity of material is the same. At the same time, since at least part of the polyelectrolyte is hydrolyzed by a strong alkali, even in the presence of the above polyelectrolyte, physical and electrical contacts between catalyst carriers are facilitated, thereby significantly improving the electrical conductivity of the catalyst carriers as a whole. Thus, electrical efficiency is improved.

The above method for manufacturing a fuel-cell electrode using the catalyst-supporting carbon is not particularly limited, and thus the above catalyst-supporting carrier can be used without modification. If desired, the method may be further comprised of a step of protonating the polymer portion of the catalyst-supporting carrier, to the surface and/or in the pores of which the electrolyte monomer precursor is polymerized, a step of drying the protonated product and dispersing it in water, and a step of filtering the dispersed substance. Similarly, the method may be further comprised of a step of changing the catalyst carrier, to the surface and in the pores of which electrolyte monomer is polymerized, into a catalyst paste, and a step of forming and shaping the catalyst paste into a predetermined shape.

In a fourth aspect, the present invention is an invention of a highly-hydrophilized carrier itself composed of a carbon carrier and polyelectrolyte. It is characterized in that polyelectrolyte exists on the surface of a carbon having pores and/or in the pores thereof, and at least part of the polyelectrolyte is hydrolyzed by a strong alkali. Since the surface of the highly-hydrophilized carrier of the present invention is thinly coated with the polyelectrolyte, it is rich in hydrophilicity. Thus, it exhibits high dispersibility without aggregating in water or the like. At the same time, since at least part of the polyelectrolyte is hydrolyzed by a strong alkali, even in the presence of the above polyelectrolyte, physical and electrical contacts between highly-hydrophilized carriers is facilitated, whereby the electrical conductivity of the highly-hydrophilized carriers as a whole is significantly improved. By utilizing such property, the invention can be widely applied to powder technologies, such as various types of catalyst carriers or toner for copying machines.

In a fifth aspect, the present invention is an invention of a catalyst-supporting carrier itself composed of a catalyst-supporting carbon and polyelectrolyte, and it is characterized in that the polyelectrolyte and the catalyst exist on the surface of a carbon having pores and/or in the pores thereof, and that at least part of the polyelectrolyte is hydrolyzed by a strong alkali. Thus, the surface and pores of the catalyst-supporting carbon can be thinly coated with the polyelectrolyte, and all the supported catalyst including the catalyst such as platinum in the pores can be effectively used. At the same time, since at least part of the polyelectrolyte is hydrolyzed by a strong alkali, even in the presence of the above polyelectrolyte, physical and electrical contacts between highly-hydrophilized carriers is facilitated, whereby the electrical conductivity of the highly-hydrophilized carriers as a whole is significantly improved. Therefore, the catalyst efficiency is significantly improved.

As described above, in order to have the molecular weight of the electrolyte monomer in an optimum and desired range, it is preferable to conduct living polymerization. Thus, for the generation of a polymerization starting point, it is preferable to use a living radical polymerization initiator or a living anion polymerization initiator. While the living radical polymerization initiator is not particularly limited, preferable examples include 2-bromo isobutyryl bromide. While the electrolyte monomer is not particularly limited, an unsaturated compound having a sulfonic acid group, a phosphate group, a carboxylic acid group, or an ammonium group can be used. Further, while the electrolyte monomer precursor is not particularly limited, an unsaturated compound capable of generating a sulfonic acid group, a phosphate group, a carboxylic acid group, or an ammonium group upon hydrolysis or the like after polymerization can be used. Among these, ethyl styrenesulfonate is preferably exemplified.

While the catalyst-supporting carrier of the present invention can be widely applied to various types of catalyst using carbon carriers, particularly, it is suitably used for a fuel-cell electrode. Thus, in a sixth aspect, the present invention is an invention of a fuel-cell electrode composed of a catalyst-supporting carbon and polyelectrolyte, and the polyelectrolyte and the catalyst are allowed to coexist on the surface of a carbon having pores and/or in the nanometer-level pores thereof. Further, at least part of the polyelectrolyte is hydrolyzed by a strong alkali.

In a seventh aspect, the present invention is an invention of a polymer electrolyte fuel cell including an anode, a cathode, a polymer electrolyte membrane disposed between the anode and the cathode. The invention characteristically includes the above fuel-cell electrode as the anode and/or the cathode.

Thus, by providing such electrode of the present invention having excellent electrode characteristics, such as the above-mentioned high catalytic efficiency, it becomes possible to structure a polymer electrolyte fuel cell having high cell output. Further, as described above, since the electrode of the present invention has high catalytic efficiency and excellent durability, the polymer electrolyte fuel cell of the present invention provided with such electrode can stably obtain high cell output over a long period of time.

### Effect of the Invention

In accordance with the present invention, polyelectrolyte can be uniformly synthesized (generated) on the surface and in the pores of a carbon carrier, and thus the hydrophilicity of the carbon carrier can be improved. Further, in accordance with the present invention, polyelectrolyte can be uniformly synthesized (generated) on the surface and in the pores of a catalyst-supporting carbon, and thus the quantity of inactive catalyst that is not in contact with the electrolyte can be reduced. Furthermore, since at least part of the polyelectrolyte is hydrolyzed by a strong alkali, even in the presence of the above polyelectrolyte, physical and electrical contacts between catalyst-supporting carbons are facilitated, and the electrical conductivity of the catalyst-supporting carbons as a whole is significantly improved, thereby increasing the catalytic efficiency.

### BRIEF DESCRIPTION OF THE DRAWINGS

FIG. 1 schematically shows a catalyst-supporting carrier composed of a catalyst-supporting carbon and polyelectrolyte, which is a conventional technology of the present invention.

FIG. 2 shows a catalyst-supporting carrier of the present invention composed of a catalyst (platinum or the like) -supporting carbon and polyelectrolyte, in which the catalyst exists on the surface and/or in the pores of the carbon, and at least part of the polyelectrolyte is hydrolyzed by a strong alkali.

FIG. 3 schematically shows a conventional catalyst-supporting carrier.

FIG. 4 shows a reaction scheme of an example of the present invention.

FIG. 5 shows effective areas of platinum per gram with respect to the electrolyte graft ratio.

FIG. 6 shows a SEM photograph of a surface of a catalyst-supporting carrier hydrolyzed by potassium hydroxide (KOH), obtained in the example.

FIG. 7 shows a SEM photograph of a surface of a catalyst-supporting carrier hydrolyzed by potassium hydroxide (KOH), obtained in the example.

FIG. 8 shows a SEM photograph of a surface of a catalyst-supporting carrier hydrolyzed by potassium hydroxide (KOH).

FIG. 9 shows a SEM photograph of a surface of a catalyst-supporting carrier hydrolyzed by sodium iodide (NaI), obtained in a comparative example.

FIG. 10 shows a current density-voltage curve as a result of a fuel-cell power generation test.

FIG. 11 shows the relationship between the graft ratio and the surface resistivity.

### BEST MODES FOR CARRYING OUT THE INVENTION

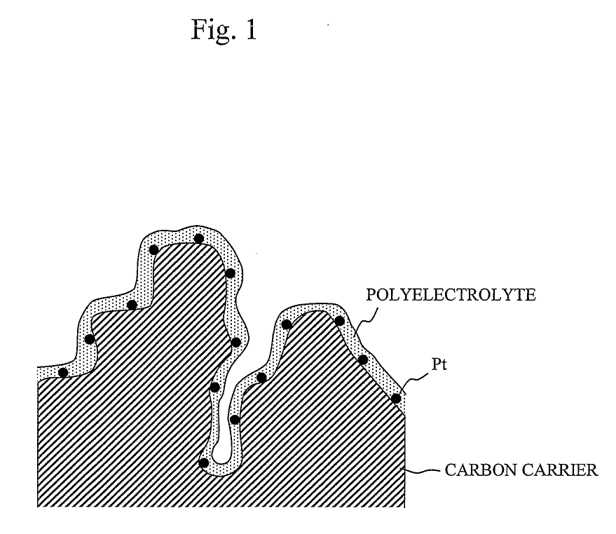

An example of a catalyst-supporting carrier of the present invention will be hereafter described. FIGS. 1 to 3 schematically show diagrams of inventive and conventional catalyst-supporting carriers. FIG. 1 shows a catalyst-supporting carrier composed of a carbon supporting catalyst, such as platinum, and polyelectrolyte, which is a conventional technology of the present invention. The catalyst exists on the surface or in the pores of the carbon. Also, the polyelectrolyte thinly and uniformly exists on the surface and in the pores of the carbon. Thus, a three-phase interface, in which reactant gas, the catalyst, and the electrolyte meet in the carbon, is sufficiently assured, whereby catalytic efficiency can be improved.

In order to create the fuel-cell electrode of FIG. 1, specifically, the polyelectrolyte is thinly and uniformly formed on the surface and/or in the nanopores of the carbon carrier by introducing a polymerization initiator to the uppermost surface of the carbon, and then mixing and polymerizing an electrolyte monomer, which is a basis of a polyelectrolyte. Thus, the monomer that can be the electrolyte is immobilized on the carbon surface. Further, since such monomer has a molecular weight of several dozens to several hundreds, it can be introduced deep into the nanopores. If polymerization is conducted in such pores, it becomes possible to utilize a great deal of submerged and non-contacted catalyst, thereby eliciting higher performance with a small quantity of catalyst.

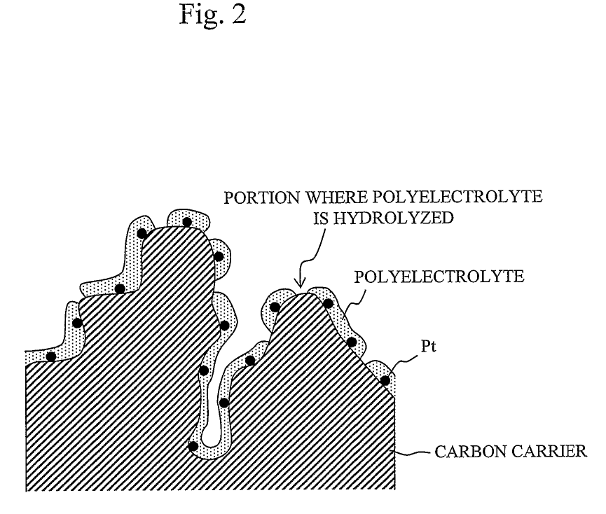

FIG. 2 shows a catalyst-supporting carrier of the present invention composed of a carbon supporting catalyst, such as platinum, and polyelectrolyte, and the catalyst exists on the surface and/or in the pores of the carbon. As in FIG. 1, the polyelectrolyte thinly and uniformly exists on the surface and in the pores of the carbon. In the catalyst-supporting carrier of the present invention, since at least part of the polyelectrolyte is hydrolyzed by a strong alkali such as potassium hydroxide (KOH), portions where part of the polyelectrolyte is removed from the surface and/or the pores of the carbon carrier due to hydrolysis are generated. Thus, carbon carriers can be favorably in contact with each other, thereby improving the electron conductivity, compared with the catalyst-supporting carrier of FIG. 1. As a result, since the three-phase interface, in which reactant gas, the catalyst, and the electrolyte meet in the carbon, is sufficiently assured, the catalytic efficiency can be improved. Further, at the same time, the electrical conductivity of the catalyst-supporting carbons as a whole is significantly improved, thereby facilitating the catalytic efficiency.

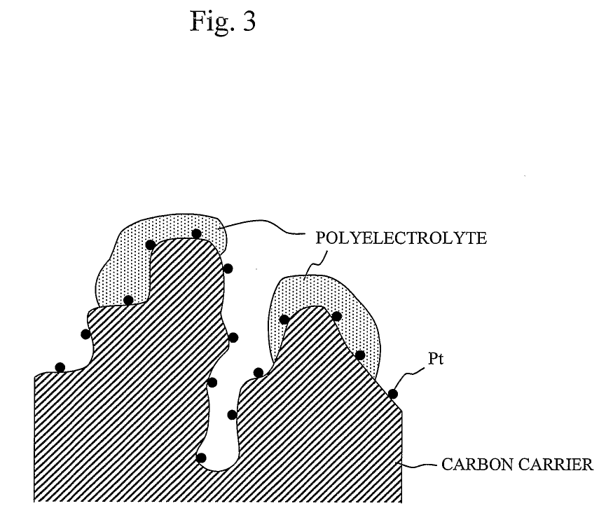

In contrast, FIG. 3 shows a conventional catalyst-supporting carrier, which is formed by sufficiently dispersing a catalyst-supporting carbon and polyelectrolyte solution such as Nafion solution in an appropriate solvent, and forming the resultant substance in the shape of a thin membrane, followed by drying. As shown in the figure, although the catalyst exists deep in the pores, the polyelectrolyte is applied only on part of the carbon surface. Thus, since part of such catalyst-supporting carrier is thickly coated, the existence of the three-phase interface, in which reactant gas, the catalyst, and the electrolyte meet, is insufficient, and the catalytic efficiency cannot be improved.

While the Nafion is dispersed in the catalyst-supporting carbon in a state of polymer in the above conventional method, the catalyst-supporting carbon is a carbon having a very large specific surface area of 1000 m²/g, and very small-sized catalyst particles having particle diameters of 2 to 3 nm at the level of a few molecules are supported by the carbon nanopores. Thus, the number of the pores to which such polyelectrolyte having a molecular weight of several thousands to several tens of thousands can be introduced is small, and a great mass of the catalyst submerged in the carbon pores is not in contact with the electrolyte, failing contribution to reaction. Conventionally, it has been said that the utilization ratio of the catalyst supported by a carbon is approximately 10%, and therefore, improving such utilization ratio in a system in which expensive platinum or the like is used as catalyst has been a longstanding problem.

Living polymerization used in the present invention is a polymerization in which an end always has activity. Alternatively, it is a quasi-living polymerization in which inactivated and activated ends are in equilibrium. The definition of living polymerization in the present invention also includes both types of polymerization. While living radical polymerization and living anionic polymerization are known as such living polymerization, living radical polymerization is preferable, from the viewpoint of polymerization operation.

The living radical polymerization is a radical polymerization in which the activity of polymer ends is not lost but maintained. In recent years, the living radical polymerization has been actively studied by various groups. Examples of the living radical polymerization employ a chain transfer agent such as polysulfide, a radical scavenger such as cobalt porphyrin complex or nitroxide compound, and Atom Transfer Radical Polymerization (ATRP) in which organohalide or the like is used as an initiator, and transition metal complex is used as a catalyst. While the method used in the present invention is not particularly limited to any of these methods, a living radical polymerization method in which the transition metal complex is used as a catalyst and the organic halide including one or a plurality of halogen atoms is used as a polymerization initiator is recommended.

In accordance with these living radical polymerization methods, generally, the polymerization rate is very high, and while it is a radical polymerization in which a termination reaction, such as coupling between radicals, easily occurs, polymerization proceeds in a living manner, a polymer having a narrow molecular weight distribution of approximately Mw/Mn=1.1 to 1.5 can be obtained, and the molecular weight can be freely controlled by a charge ratio of the monomer to the initiator.

In the following, a preferred example of a fuel-cell electrode of the present invention and a polymer electrolyte fuel cell provided with such fuel-cell electrode will be further described.

While an electrode in a polymer electrolyte fuel cell of the present invention includes a catalyst layer, it is preferable that the electrode includes the catalyst layer and a gas diffusion layer disposed adjacent to the catalyst layer. Examples of material that constitutes the gas diffusion layer include a porous body having electron conductivity (carbon cloth or carbon paper, for example).

Carbon black particles, for example, can be used for the catalyst-supporting carbon, and a platinum group metal, such as platinum or palladium, can be used for catalyst particles.

The present invention particularly provides advantageous effects when the specific surface area of the carbon exceeds 200 m²/g. Namely, on the one hand, such carbon having a large specific surface area has many nano-sized minute pores on the surface thereof and thus has good gas diffusivity, but on the other hand, catalyst particles that exist in the nano-sized minute pores do not contribute to reaction since they are not in contact with the polyelectrolyte. In this respect, in the present invention, catalyst particles dispersed in the polyelectrolyte are in contact with the polyelectrolyte in the nano-sized minute pores, and thus effectively utilized. Namely, in the present invention, the gas diffusivity can be improved while maintaining the reaction efficiency.

The catalyst-supporting carrier and the polymer electrolyte fuel cell of the present invention will be hereafter described in detail with examples.

### EXAMPLE

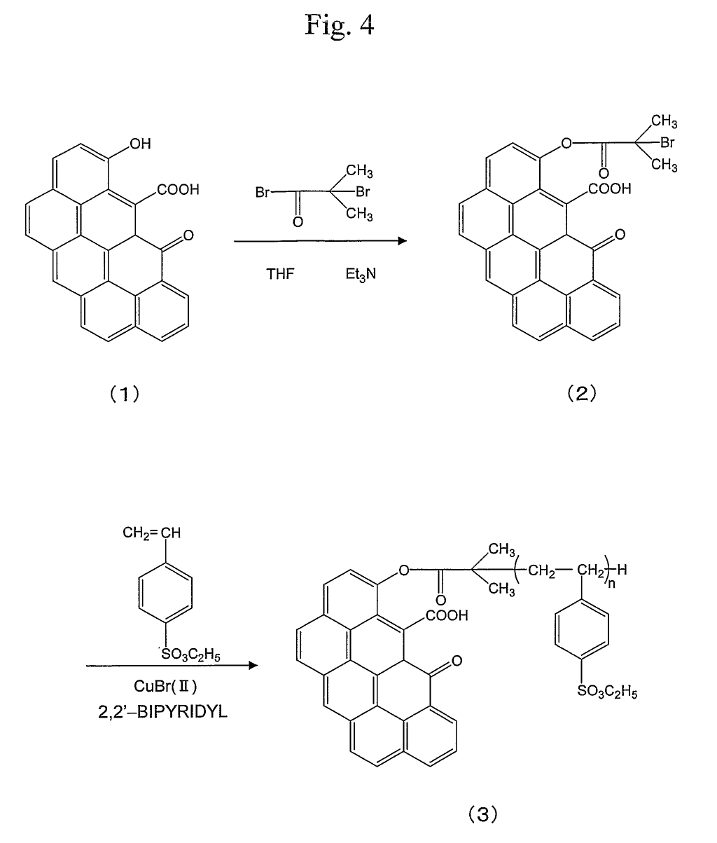

FIG. 4 shows a reaction scheme of the present example.

First, a functional group functioning as an initiator of living radical polymerization was introduced to 10 g of platinum-supporting carbon particles. As a catalytic carbon, VULCANXC 72 (carbon carrier) was allowed to support 60% by weigh of Pt. The carbon carrier includes (1) hydroxyl groups, carboxyl groups, carbonyl groups, and the like in a carbon condensed ring. Among these, the hydroxyl groups react with the initiator of living radical polymerization. While such catalytic carbon originally includes hydroxyl groups, a nitric acid treatment may be further conducted to adjust the number of hydroxyl groups. In THF, 2-bromo isobutyryl bromide was allowed to react with phenolic hydroxyl contained in the carbon particles, in the presence of a base (triethylamine), so as to introduce a functional group functioning as a starting point of living radical polymerization to the carbon particles (2).

Next, a polymer having a sulfonic acid group in a side chain thereof was grafted to the platinum-supporting carbon particles. About 9.5 g (2) of platinum-supporting carbon particles, which was obtained by the above reaction and to which the functional group functioning as an initiator of living radical polymerization had been introduced, was introduced into a round-bottom flask. After deoxidation was carried out by injecting argon gas, ethyl styrenesulfonate (ETSS manufactured by Tosoh corp.) was gradually poured. After further deoxidation, nickelous bromide bis-tri-n-butylphosphine: (NiBr₂(n-Bu₃P)₃, which is a catalyst and a transition metal compound, was added. After sufficient agitation, the temperature was increased, and living radical polymerization was initiated without a solvent. Thus, the platinum-supporting carbon particles, to which a polymer having an ethylsulfonic acid group in a side chain thereof was grafted, were obtained (3). The polymerization degree n of ethyl styrenesulfonate, which is the unit of repetition, can be freely adjusted by the charge of ethyl styrenesulfonate. While not particularly limited, it is approximately 5 to 100, preferably, 10 to 30.

Potassium hydroxide (KOH) as a strong alkali was added to about 9.0 g of the obtained dispersion liquid containing platinum-supporting carbon particles to which the polymer having an ethylsulfonic acid ethyl group in a side chain had been grafted. After the ethylsulfonic acid ethyl group was hydrolyzed and protonated by potassium sulfonate, hydrogen was substituted for the potassium by using excess sulfuric acid, thereby obtaining a sulfonic acid group. The obtained catalyst-supporting carbon was washed with pure water. Next, about 9.0 g of product was obtained after filtration and drying.

### COMPARATIVE EXAMPLE

The same operation as that of Example was conducted, except that the polymer having an ethylsulfonic acid ethyl group in a side chain thereof was hydrolyzed by using sodium iodide (NaI), instead of potassium hydroxide (KOH).

### Effective Surface Area of Platinum Per Gram

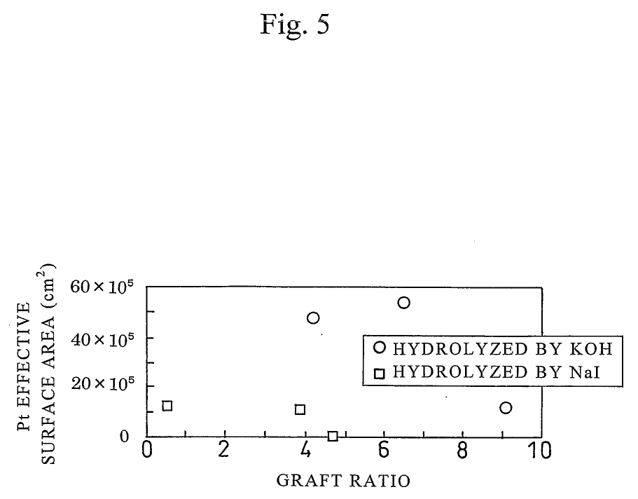

The polymerization degree was determined by potentiometric titration of the sulfonic acid group. Cyclic voltammetry was performed with respect to the obtained catalyst layer, so as to obtain the effective surface area of platinum per gram. FIG. 5 shows the relationship between the graft ratio and the effective surface area of platinum per gram.

From the results shown in FIG. 5, it is conceivable that while sodium iodide (NaI) mainly accelerates the hydrolysis of the ethylsulfonic acid ethyl group, potassium hydroxide (KOH), which is a strong alkali, not only affects the hydrolysis of the ethylsulfonic acid ethyl group, but also binding between the carrier and the polyelectrolyte; that is, the hydrolysis of the ester group functioning as a starting point of graft polymerization from the carbon particle carrier in the above formula (3).

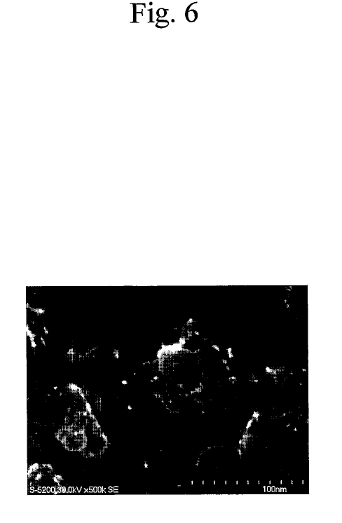

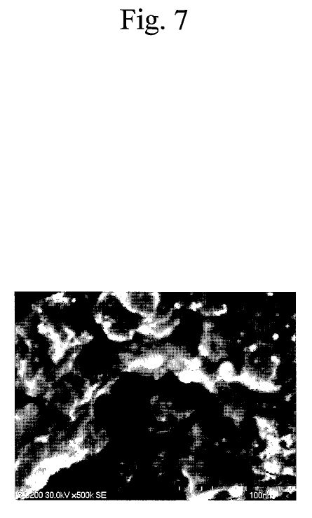

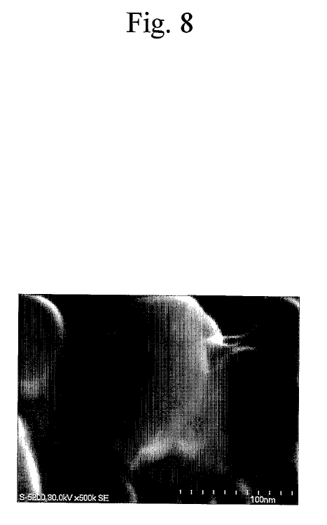

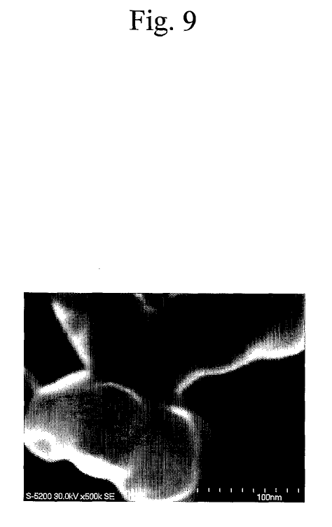

FIGS. 6 to 8 show SEM photographs of surfaces of the catalyst-supporting carriers hydrolyzed by potassium hydroxide (KOH). FIG. 6 shows a case in which the graft ratio was 4.2%, FIG. 7 shows a case in which the graft ratio was 6.6%, and FIG. 8 shows a case in which the graft ratio was 9.1%. FIG. 9 shows a SEM photograph of a surface of the catalyst-supporting carrier hydrolyzed by sodium iodide (NaI), which was obtained in the comparative example. FIG. 9 shows a case in which the graft ratio was 4.7%. It can be seen that while not only was the ethylsulfonic acid ethyl group hydrolyzed, but also the ester group, which was a binding between the carrier and the polyelectrolyte, was hydrolyzed in FIGS. 6 and 7, the ethylsulfonic acid ethyl group alone was hydrolyzed in FIGS. 8 and 9.

### Discharge Evaluation

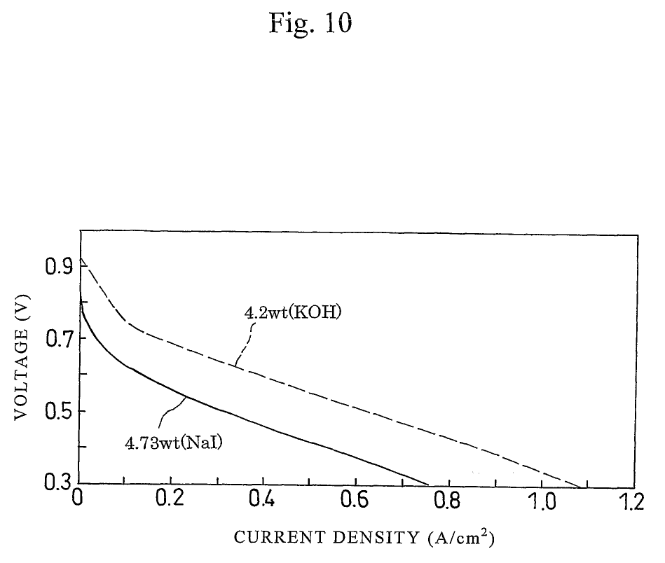

The synthesized catalyst layer was bonded to a fuel-cell electrolyte membrane, and an MEA was made. A fuel-cell power generation test was conducted by using this MEA. FIG. 10 shows a current density-voltage curve as a result of the test.

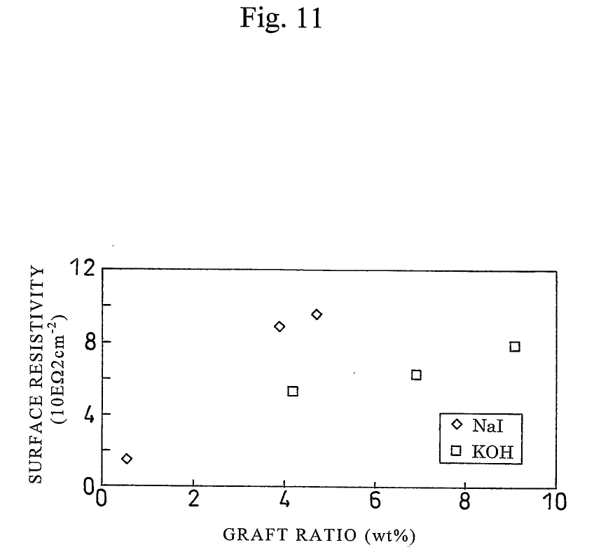

Further, the quantification of electronic conductivity was measured three times by a four-terminal method, and an average value was determined. FIG. 11 shows the relationship between the graft ratio and the surface resistivity.

From the results shown in FIGS. 10 and 11, it has proven that the catalyst-support carbon of the present invention hydrolyzed by potassium hydroxide (KOH), which is a strong alkali, further improved the performance of the MEA, as compared with the MEA using the catalyst-supporting carbon hydrolyzed by sodium iodide (NaI).

### INDUSTRIAL APPLICABILITY

According to the present invention, a three-phase interface, in which reactant gas, catalyst, and electrolyte meet in a carbon, is sufficiently assured, and thus catalyst use efficiency can be improved. Simultaneously, since at least part of the polyelectrolyte is hydrolyzed by a strong alkali, in spite of the presence of the above polyelectrolyte, physical and electrical contacts between catalyst carriers are facilitated, whereby the electric conductivity of the catalyst carriers as a whole is significantly improved. By applying such catalyst carrier to a fuel cell, electrode reaction is effectively facilitated, and the electrical efficiency of a fuel cell can be improved. Further, it is possible to obtain an electrode having excellent properties, and a polymer electrolyte fuel cell that is provided with such electrode and that is capable of obtaining high cell output. Thus, the catalyst-supporting carrier of the present invention can be widely applied to various types of catalyst using carbon carriers. Particularly, since it can be suitably used for a fuel-cell electrode, it contributes to a widespread use of a fuel cell.

1. A method for manufacturing a highly-hydrophilized carrier comprised of a carbon carrier and polyelectrolyte, the method comprising:
introducing a functional group functioning as a polymerization initiator to the surface of a carbon carrier having pores and/or in the pores thereof;
introducing an electrolyte monomer or an electrolyte monomer precursor, and polymerizing the electrolyte monomer or the electrolyte monomer precursor to the polymerization initiator as a starting point; and
hydrolyzing at least part of the polymerized polyelectrolyte by a strong alkali.

2. The method for manufacturing a highly-hydrophilized carrier according to claim 1, wherein at least part of the polyelectrolyte is hydrolyzed by KOH and/or NaOH.

3. The method for manufacturing a highly-hydrophilized carrier according to claim 1, wherein the polymerization initiator is either a living radical polymerization initiator or a living anion polymerization initiator.

4. The method for manufacturing a highly-hydrophilized carrier according to claim 3, wherein the living radical polymerization initiator is 2-bromo isobutyryl bromide.

5. The method for manufacturing a highly-hydrophilized carrier according to claim 1, wherein the ratio of the weight of the electrolyte to the sum of the weight of the electrolyte and the weight of the catalyst-supporting carbon is less than 10% in the step of polymerizing the electrolyte monomer or the electrolyte monomer precursor.

6. The method for manufacturing a highly-hydrophilized carrier according to claim 5, wherein the ratio of the weight of the electrolyte to the sum of the weight of the electrolyte and the weight of the catalyst-supporting carbon is adjusted by the concentration of the electrolyte monomer or the concentration of the electrolyte monomer precursor in the step of polymerizing the electrolyte monomer or the electrolyte monomer precursor.

7. The method for manufacturing a highly-hydrophilized carrier according to claim 1, wherein, after the electrolyte monomer precursor is polymerized, the method comprises a step of hydrolyzing the polymer or introducing an ion-exchange group.

8. The method for manufacturing a highly-hydrophilized carrier according to claim 1, wherein the electrolyte monomer precursor is ethyl styrenesulfonate.

9. A method for manufacturing a catalyst-supporting carrier comprised of a catalyst-supporting carbon and polyelectrolyte, the method comprising:
allowing a carbon having pores to support catalyst;
introducing a functional group functioning as a polymerization initiator to the surface and/or in the pores of the catalyst-supporting carbon;
introducing an electrolyte monomer or an electrolyte monomer precursor, and polymerizing the electrolyte monomer or the electrolyte monomer precursor to the polymerization initiator as a starting point; and
hydrolyzing at least part of the polymerized polyelectrolyte by a strong alkali.

10. The method for manufacturing a catalyst-supporting carrier according to claim 9, wherein part of the polyelectrolyte is hydrolyzed by KOH and/or NaOH.

11. The method for manufacturing a catalyst-supporting carrier according to claim 9, wherein the polymerization initiator is either a living radical polymerization initiator or a living anion polymerization initiator.

12. The method for manufacturing a catalyst-supporting carrier according to claim 11, wherein the living radical polymerization initiator is 2-bromo isobutyryl bromide.

13. The method for manufacturing a catalyst-supporting carrier according to claim 9, wherein the ratio of the weight of the electrolyte to the sum of the weight of the electrolyte and the weight of the catalyst-supporting carbon is less than 10% in the step of polymerizing the electrolyte monomer or the electrolyte monomer precursor.

14. The method for manufacturing a catalyst-supporting carrier according to claim 13, wherein the ratio of the weight of the electrolyte to the sum of the weight of the electrolyte and the weight of the catalyst-supporting carbon is adjusted by the concentration of the electrolyte monomer or the concentration of the electrolyte monomer precursor in the step of polymerizing the electrolyte monomer or the electrolyte monomer precursor.

15. The method for manufacturing a catalyst-supporting carrier according to claim 9, wherein, after the electrolyte monomer precursor is polymerized, the method comprises a step of hydrolyzing the polymer or introducing an ion-exchange group.

16. The method for manufacturing a catalyst-supporting carrier according to claim 9, wherein the electrolyte monomer precursor is ethyl styrenesulfonate.

17. A method for manufacturing a fuel-cell electrode, wherein the catalyst-supporting carrier according to claim 9 is used for the fuel-cell electrode.

18. The method for manufacturing a fuel-cell electrode according to claim 17, wherein the method further comprises:
protonating the polymer portion of the catalyst-supporting carrier, on the surface and/or in the pores of which the electrolyte monomer precursor is polymerized,
drying the protonated product and dispersing it in water; and
filtering the dispersed substance.

19. The method for manufacturing a fuel-cell electrode according to claim 18, wherein the method further comprises:
changing the catalyst-supporting carrier, to the surface and/or in the pores of which the electrolyte monomer or the electrolyte monomer precursor is polymerized, into a catalyst paste; and
forming and shaping the catalyst paste into a predetermined shape.

20. A highly-hydrophilized carrier comprised of a carbon carrier and polyelectrolyte, wherein the polyelectrolyte exists on the surface of a carbon having pores and/or in the pores thereof, and at least part of the polyelectrolyte is hydrolyzed by a strong alkali.

21. The highly-hydrophilized carrier according to claim 20, wherein the ratio of the weight of the polyelectrolyte to the sum of the weight of the polyelectrolyte and the weight of the catalyst-supporting carbon is less than 10%.

22. The highly-hydrophilized carrier according to claim 20, wherein the polyelectrolyte is formed by the polymerization of an electrolyte monomer or an electrolyte monomer precursor to the surface and/or the pores of the carbon carrier as a polymerization starting point.

23. The highly-hydrophilized carrier according to claim 22, wherein the polymerization starting point is based on either a living radical polymerization initiator or a living anion polymerization initiator.

24. The highly-hydrophilized carrier according to claim 23, wherein the living radical polymerization initiator is 2-bromo isobutyryl bromide.

25. The highly-hydrophilized carrier according to claim 20, wherein the electrolyte monomer is ethyl styrenesulfonate.

26. A catalyst-supporting carrier comprised of a catalyst-supporting carbon and polyelectrolyte, wherein the polyelectrolyte and catalyst exist on the surface of a carbon having pores and/or in the pores thereof, and at least part of the polyelectrolyte is hydrolyzed by a strong alkali.

27. The catalyst-supporting carrier according to claim 26, wherein the ratio of the weight of the polyelectrolyte to the sum of the weight of the polyelectrolyte and the weight of the catalyst-supporting carbon is less than 10%.

28. The catalyst-supporting carrier according to claim 26, wherein the polyelectrolyte is formed by the polymerization of an electrolyte monomer or an electrolyte monomer precursor to the surface and/or the pores of the catalyst-supporting carbon as a polymerization starting point.

29. The catalyst-supporting carrier according to claim 28, wherein the polymerization starting point is based on either a living radical polymerization initiator or a living anion polymerization initiator.

30. The catalyst-supporting carrier according to claim 29, wherein the living radical polymerization initiator is 2-bromo isobutyryl bromide.

31. The catalyst-supporting carrier according to claim 26, wherein the electrolyte monomer precursor is ethyl styrenesulfonate

32. A fuel-cell electrode, wherein the catalyst-supporting carrier according to claim 26 is used for the fuel-cell electrode.

33. A polymer electrolyte fuel cell comprising an anode, a cathode, and a polymer electrolyte membrane disposed between the anode and the cathode, wherein the fuel-cell electrode according to claim 32 is provided as the anode and/or the cathode.
